(19) United States
(12) Patent Application Publication
(10) Pub. No.: US 2024/0226676 A9
(43) Pub. Date: Jul. 11, 2024

(54) HYBRID RUBBER GRIP COMPOSITIONS AND RELATED METHODS

(71) Applicant: Lamkin Corporation, San Diego, CA (US)

(72) Inventor: Jorge Gonzalez, San Diego, CA (US)

(21) Appl. No.: 18/239,034

(22) Filed: Aug. 28, 2023

Related U.S. Application Data
(60) Provisional application No. 63/402,041, filed on Aug. 29, 2022.

(51) Int. Cl. A63B 53/14; A63B 60/14; A63B 60/16; B29C 43/00; B29C 43/18; B29C 43/34; C08L 9/00

(52) U.S. Cl. CPC A63B 53/14; A63B 60/14; A63B 60/16; B29C 43/003; B29C 43/18; B29C 43/34; C08L 9/00; A63B 2209/00; B29C 2043/182; B29L 2031/5227

(57) ABSTRACT

Provided herein are rubber mixture compositions, methods of making same and golf grips.

### CROSS-REFERENCE TO RELATED APPLICATIONS

This application claims the benefit of U.S. Provisional Patent Application. 63/402,041, filed Aug. 29, 2022, all of which is incorporated herein by reference in its entirety for all purposes.

### BACKGROUND OF THE INVENTION

### Field of the Invention

A rubber grip for a sporting implement is made from a rubber mixture composition provided herein.

### Description of Relevant Art

Grips for sporting implements have taken numerous forms for many years with early grips for golf clubs, tennis rackets and the like simply consisting of a wrap of material, such as leather, in a helical or spiral pattern around a handle portion of the sporting implement. In recent years, the leather material has been replaced in some circumstances with polyurethane and rather then wrapping the polyurethane or leather strip of material directly onto the handle portion of the sporting implement, sometimes an elastomeric tubular underlisting is first mounted on the handle portion of the implement so the strip leather or polyurethane material can be wrapped onto the underlisting.

In the sport of golf, grips have evolved from the wrap type grip described above to vulcanized rubber sleeves that are simply slipped over the butt end of the golf club. Such grips are still in use and typically made of one uniform rubber material. To improve the frictional gripping quality of the grip for the user of the club, a pattern is frequently molded into the outer surface of the grip. Since the grip on a golf club and other sporting implements must have a desired degree of torsional resistance, the rubber material from which the grips are made must be relatively hard which is sometimes undesirable from the aspect of obtaining the desired friction between the grip and the user's hands. Further, hard rubber materials tend to become harder and slippery over time and with repeated use.

Accordingly, grips made of more than one rubber material or even thermoplastic materials have recently come into existence. An example of such a grip is disclosed in copending application Ser. No. 09/779,029 entitled “Grip For Sporting Implement” which is of common ownership with the present application. In the pending application, an underlisting of a relatively hard rubber material is provided with a recess in its outer surface in which a tubular sleeve of a softer material is positioned. This combination provides the torsional resistant base desired for the grip with a relatively soft rubber gripping surface desired by some users.

U.S. Pat. No. 3,090,999 to Karns, U.S. Pat. No. 5,322,290 to Minami and U.S. Pat. No. 5,261,665 to Downey are other illustrations of grips having multiple layers of material with the layers being made of materials of varying hardness.

It is known that conventional mixing process of EPDM or Bromobutyl (BIIR) rubber is always a big challenge for rubber compounders. Typically, the major mixing obstacles for mixing semi-crystalline EPDM or Bromobutyl rubber are a poorly mixed compound and a long mixing cycle. There are various factors contributing to the mixing behavior of both rubbers that are totally different. While Bromobutyl rubber is high viscosity and sticky property and the EPDM is non-polar too so manufacturing EPDM/BIIR blend requires the use of many ingredients as reinforcing fillers, extending fillers, process oils, stabilizers, curatives and other additives.

A conventional and by separated EPDM or BIIR manufacturing process consists of multiple steps, including mixing (one pass or multiple pass mixing); shaping (extrusion, calendaring or molding); and vulcanization/curing system by Sulfur. Generally speaking, the typical mixing process includes three stages, including wetting of ingredients and incorporation of ingredients into rubber, breaking up of agglomerates, dispersion and distribution of ingredients into the rubber matrix.

The numbers correspond to the following: 1) fragment rubber; 2) distribute powders and liquids; 3) incorporate powders and liquids; 4) fuse fragments; 5) break down carbon black; 6) disperse carbon black; 7) break down rubber and black-polymer interaction; and 8) shape compound.

It is to overcome the shortcomings of the prior art and to provide a new grip material and method of making the grip in a molding process that the present invention has been developed.

### SUMMARY OF THE INVENTION

The present invention relates to a grip for a sporting implement made of a particularly advantageous rubber mixture composition comprising: a first rubber that can be crosslinked via peroxide (e.g., EPDM) and at least one second rubber that substantially-cannot be crosslinked by peroxide (e.g., BIIR), such that when an outer layer of the grip comprising this particular rubber mixture composition is compression molded to an inner tubular base member, it provides a maximum feeling of wet-tackiness, preferably without the need for any subsequent grinding of the grip surface.

The invention rubber mixture (blend) composition of rubbers provides the increase benefit of improved tackiness feel properties compared to the feel achieved by using each of the rubbers independently. The new chemistry characteristics of the invention rubber mixture composition also advantageously provides the ability to add raw materials as fillers, different elastomers, plastics or thermosets, fibers, blowing agents, glass bubbles to reduce specific gravity to the material until 0.94), glass beads for lightweight densities, pigments, and the like, each of which can further expand the material properties.

More particularly, the benefits and advantages provided by the invention rubber mixture composition include: High Tackiness texture; Low permeability; Vibration damping; Resistance to UV Exposure, ozone, aging, Temperature stability to high and low weather condition; Water resistant—Hydrophobicity resistance; Wide hardness range from 30A to 70A; Low absorption to external oils and dust; and the like.

In one embodiment, the grip is made in accordance with a method set forth in U.S. Pat. No. 7,264,759, wherein the inner tubular base member or underlisting is injection molded from rubber and then placed in a heated compression mold with strips of the invention “rubber mixture composition” material laid in overlying relationship therewith. The mold is subsequently closed and heated under pressure so that the strips of relatively soft “rubber mixture composition” material are vulcanized to the tubular underlisting. Also, during the compression molding process, in particular embodiments an end cap can be placed in the mold in abutting relationship with a butt end of the tubular underlisting and tabs of a different or the same rubber material as the underlisting can be placed in adjacent contiguous relationship with the opposite or tip end of the underlisting. In this manner, after the completion of the compression molding process, the end cap is vulcanized to the butt end of the underlisting, the strips of relatively soft “rubber mixture composition” material are vulcanized in circumferentially surrounding relationship with the underlisting and the tabs of material form an integral cylindrical flap or skirt at the tip end of the grip to facilitate the ease of placement of the grip onto the butt end of a golf club shaft or the like. To support the underlisting during the compression molding process a mandrel can be placed in the hollow center of the underlisting.

Other aspects, features and details of the present invention can be more completely understood by reference to the following detailed description of a preferred embodiment, taken in conjunction with the drawings and from the appended claims.

### BRIEF DESCRIPTION OF THE DRAWINGS

FIG. 1 is an isometric view of a golf club having the compression molded grip of the present invention mounted thereon.

FIG. 2 is an enlarged fragmentary isometric view of the grip portion of the golf club shown in FIG. 1.

FIG. 3 is a section taken along line 3-3 of FIG. 2.

FIG. 4 is an enlarged section taken along line 4-4 of FIG. 3

FIG. 5 is a side elevation of the underlisting forming part of the grip of the present invention.

FIG. 6 is an end view of the underlisting shown in FIG. 5 forming part of the grip of the present invention.

FIG. 7 is a top plan view of a strip of material used in the grip of the present invention.

FIG. 8 is an end elevation of the strip shown in FIG. 7.

FIG. 9 is an end elevation of the end cap used in the grip of the present invention.

FIG. 10 is a side elevation of the end cap shown in FIG. 9.

FIG. 11 is a plan view of a tab of material used to form the skirt of the grip of the present invention.

FIG. 12 is an edge view of the tab shown in FIG. 11.

FIG. 13 is an exploded isometric view showing the various component parts of the grip of the present invention and the compression mold parts used to form the grip of the present invention.

FIG. 14 is an exploded isometric view with the mold halves separated and with a strip material and tab material having been placed in one half of the compression mold, the underlisting for the grip mounted on a mandrel prior to being placed in the mold, the end cap mounted on the plunger, and a second strip material and tab material superimposed over the underlisting for placement thereon.

FIG. 15 is an isometric view similar to FIG. 14 showing the underlisting with the mandrel therein having been placed in the lower half of the mold with the second strip of material and tab having been laid over the underlisting and the plunger inserted into the mandrel.

FIG. 16 is an isometric view similar to FIG. 15 with the mold halves having been placed in closed confronting relationship.

FIG. 17 is a section taken along line 17-17 of FIG. 14.

FIG. 18 is a section taken along line 18-18 of FIG. 15.

FIG. 19 is a section taken through the closed mold with the components therein.

FIG. 20 is a vertical section taken through the mold with the halves of the mold having been separated and the completed grip being positioned therebetween.

FIG. 21 shows a diagram of the combination of three different elements: a mixture of Bromobutyl rubber, EPDM rubber, and a Peroxide cure system.

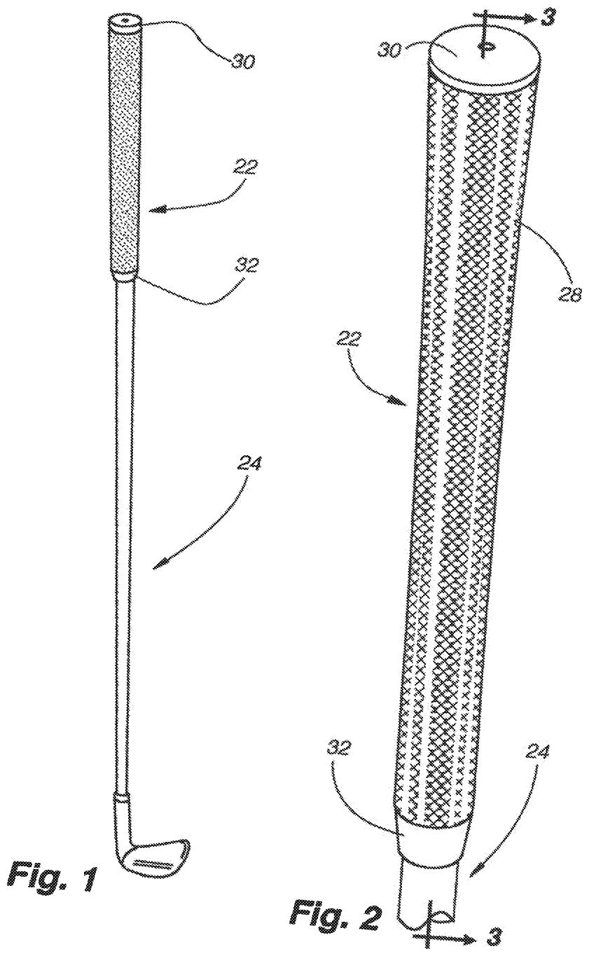

### DESCRIPTION OF THE PREFERRED EMBODIMENT

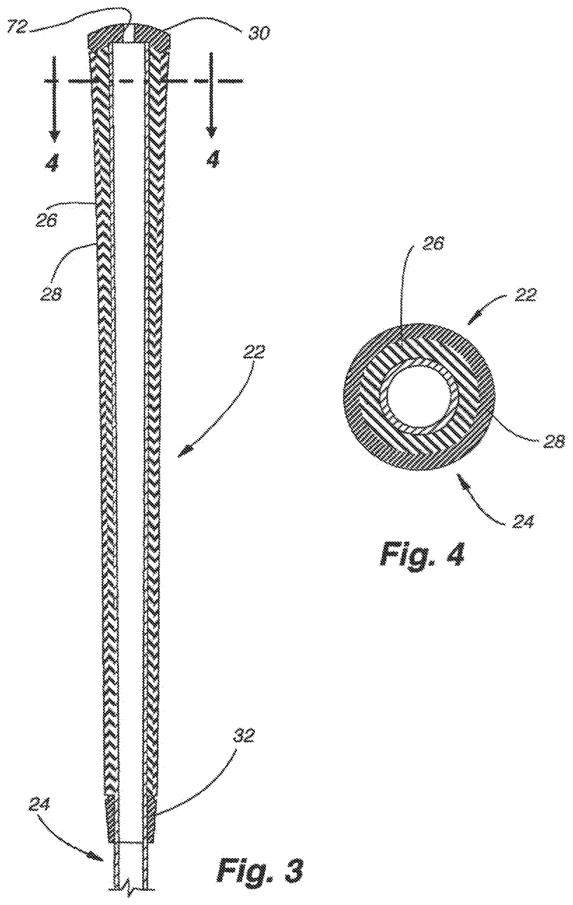

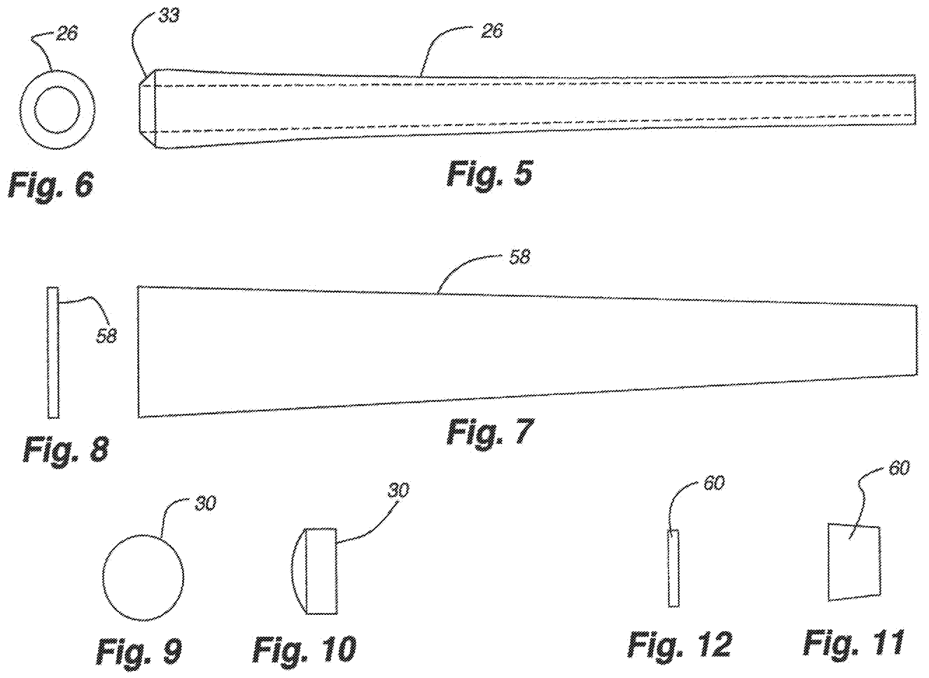

A grip 22 for a sporting implement is described hereafter in connection with a golf club 24, it being understood that the grip and the method of manufacturing the grip could be utilized in connection with other sporting implements such as tennis rackets and the like. As possibly best appreciated in FIG. 3, in on embodiment, the grip 22 includes a tubular base member or underlisting 26 with an outer circumferential layer 28 of a relatively soft invention “rubber mixture composition” material that has been compression molded and vulcanized to the underlisting. An end cap 30 is compression molded and vulcanized to the butt end 26 b of the underlisting and a flexible collar or skirt 32 is compression molded and vulcanized to the tip end 26 t of the underlisting.

As used herein, the phrase “rubber mixture composition” or “elastomeric rubber mixture composition material” or “rubber mixture composition material”, or grammatical variations thereof, refers to a hybrid rubber material comprising: a first rubber that can be crosslinked via peroxide and at least one second rubber that substantially-cannot be crosslinked by peroxide, such that the final hybrid mixture maintains a high level of tackiness performance in a range of very low to high durometers including different textures. In other words, the invention hybrid rubber mixture composition is a hybrid formula composition that blends elastomers and polymers at once to create the maximum feeling of tackiness while achieving a high level performance rubber compounding for molding sporting grips. More particularly, when an outer layer of a golf grip comprising this particular rubber mixture composition is compression molded to an inner tubular base member, it provides a maximum feeling of wet-tackiness. In one embodiment, the grip is ready for use without the need for any subsequent grinding of the grip surface.

In a particular embodiment, the hybrid rubber mixture composition comprises EPDM (can be crosslinked via peroxide) and a butyl rubber (IIR)(cannot be crosslinked using peroxide), such as bromobutyl rubber (BIIR) and/or chlorobutyl rubber (CIIR). In one embodiment, the hybrid rubber mixture composition comprises EPDM and bromobutyl rubber. In another embodiment, the hybrid rubber mixture composition comprises EPDM and chlorobutyl rubber.

In yet further embodiments, other first rubbers that can be crosslinked via pereoxide can be selected from the group consisting of: Natural rubber (NR), Polyisoprene (IR), Polybutadiene (BR), Polychloroprene (CR), Styrene butadiene rubber (SBR), Nitrile rubber (NBR), Hydrodenated nitrile rubber (HNBR), Silicone (Q), Polyurethane (AU/EU), Ethylene propylene copolymer (EPU), Ethylene propylene terpolymer (EPDM), Polyolefin elastomer (POE), Polysulfide (T), Polyethylene (PE), Chlorinated polyethylene (CM), Chlorosulfonated polyethylene (CSM), Ethylene vinylacetate copolymer (EVA), Acrylonitrile butadien styrene copolymer (ABS), Ethylene acrylic (AEM), Ethylene butylacrylate copolymer (EBA), Fluoro elastomers (FKM). In addition, other first rubbers that can be crosslined via pereoxide include blends selected from the group consisting of: Nitrile rubber/EPDM, SBR/EPDM, PE/EPDM (TPV's), PE/EVA, NBR/EVA, POE/EPM and POE/EPDM.

In yet further embodiments, other second rubbers, in addition to Bromobuty rubber and Chlorobutyl rubber, that cannot be crosslinked via pereoxide can be selected from the group consisting of: Polyacrylate (ACM), Epichlorohydrin (CO), Epichlorohydrin copolymer (ECO), Polypropylene (PP), Polybutene-1 (PB), Polyisobutene (PIB), and Polyvinylchloride (PVC).

In other embodiments, the invention rubber mixture composition material can further be reinforced by combing it with other polymers, such as for example, polybutadiene, SBR, Natural rubber, PU rubber, and the like. In other embodiments, the invention rubber mixture composition can be processed using different manufacturing process selected from: Injection solid rubber grip in single color or multi color; Injection sleeve rubber grip in single color or multi color; Compression process of solid rubber grip in single color or multi color; Compression process of sleeve rubber grip in single color or multi color; and Compression process of solid rubber grip in single color or multi color including cord or any fiber material.

As set forth herein, although in particular embodiments there is no finishing required (non-buffed surface) and the grip is ready for final use directly out of the mold, in other embodiments, buffed surface finishing well known to those of skill in art is employed. For example, in particular embodiments, (referred to as Sonar UltraTac, Sonar UltraTac Wrap grip), the rubber grips out of the molding without any grind of the grip surface, but is finished in the non-fingerprint area the using an abrasive wheel, such as 7 FINE. In other embodiments, (referred to as UltraTac R.E.L, UT'x, Crossline, and TOUR) the whole body of the grip is finished by using two passes of an abrasive wheel, such as FINE-Medium grain NWBB. These finishing methods and designs are set forth in the following US Utility and Design Patents, each of which are incorporated herein by reference in their entirety for all purposes: U.S. Pat. Nos. 8,541,497; 8,334,337; 6,666,777; 9,199,146; 9,302,164; 9,486,678; 7,264,759; 10,130,858; 11,273,347; D394889; D383822; D664225; D735825; D781386; D788865; D788866; D664224 and D667223.

Accordingly, the invention rubber mixture composition material has been developed to offer a high performance, hand grip technology, to improve contact surface and tack feeling for golf grips or any other hand grip application (e.g., Tennis Grips, Racquetball Grips, Bicycle grips, Pickleball grips, and the like). In a particular embodiment, the Halogenated rubber (BIIR) combined with Synthetic rubber (EPDM) properties provides a strengthened new rubber blend that provides a maximum tackiness feeling for a longer period of time, which is an advantage over conventional rubbers.

In further embodiments, combining the invention rubber mixture composition materials with fingerprint textures designs, creates a grip design performance that is very comfortable, tackier and has higher adhesion. In other embodiments, as is well-known to those of skill in the art, the type of texturing design selected provides the invention rubber mixture composition material with different degrees of roughness as is common in grip design, which highlights yet another advantage of this application.

In yet another embodiment, the finishing process of the grip is part of the improvement of the strengthened surface and cosmetic/appearance of the grip using the rubber mixture composition material. For example, in this embodiment, the rubber grip can be used directly from the molding without any grind of the grip surface, which results in a highly wet-tacky feeling grip having that maintains a fresh, shiny surface for a longer period of time.

### Method of Making an EPDM/BIIR Rubber Mixture Composition:

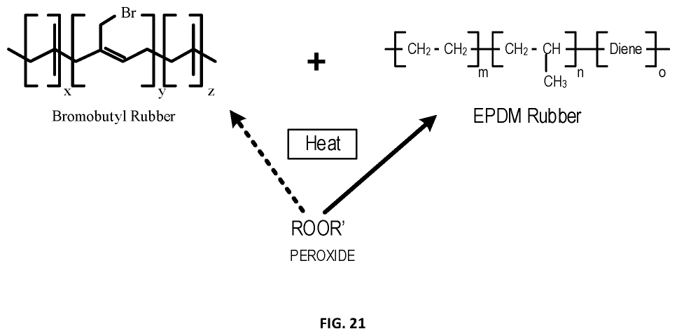

In one embodiment, the invention rubber mixture composition material is a hybrid rubber combining the following three different elements (see FIG. 21) in a variety of ratios (Table1): a mixture of Bromobutyl rubber (derived from halogenating butyl rubber with bromine in a continuous process), EPDM rubber (ethylene propylene diene monomer that is an elastomer of a type of synthetic rubber) and Peroxide cure system (pure liquid peroxide that is a bifuntional peroxide to crosslinking different rubbers except the Bromobutyl rubber).

In particular embodiments, halobutyl rubber & EPDM rubber are processed on conventional rubber equipment including mills, internal mixers (Banbury), calenders and extruders. In one embodiment, the process for making a specific invention rubber mixture composition of Halobutyl rubber & EPDM is the result of new and different milling instructions relative to the prior art, so as to get proper vulcanization of the rubber. Because when using the peroxide curing system in accordance with the present invention, only the EPDM part is cured and the part containing Halobutyl rubber is uncured, which maximizes the tacky feeling. A general example of the new process for making the invention rubber mixture composition includes: order of adding materials, increase temperatures, pre-mixing both rubbers together and use peroxide to cure only one of the two rubbers.

An advantageous early step in the invention process of making the invention rubber mixture composition comprises premixing the EPDM together with the Bromobutyl rubber for about 2 minutes in a Banbury machine (temperature 62° F.-72° F.). In other embodiments, other premixing times contemplated herein include about 10 seconds up to about 10 minutes. More particularly, other premixing times contemplated herein include 10, 20, 30, 40 seconds, 50 seconds, 1 minute, 70, 80, 90, 100, 110, 2 minutes, 130, 140, 150, 160, 170, 3 minutes, 3.5, 4, 4.5, 5, 5.5, 6, 6.5, 7, 7.5, 8, 8.5, 9, 9,5 and 10 minutes, or longer. Other temperature ranges contemplated herein include about 40° F. up to about 90° F.; about 50° F. up to about 80° F.; 55° F. up to about 75° F., and the like.

This first pre-mixing step is a particularly advantageous step in the overall manufacturing process because an “upside down” mix procedure was used; which means that at the first stage EPDM & BIIR were first added to reduce the high viscosity and sticky material of Bromobutyl (BIIR); and then the following were added: carbon black, silica, oil process, PEG, stearic acid and at same time zinc oxide & Peroxide (cured system) to start the reaction with the EPDM part.

The batch weight was sized to have a 60% fill factor. Other fill factors contemplated herein for batch weight include about 30% up to about 90%. More particularly, other fill factors contemplated herein can be selected from 30, 35, 40, 45, 50, 55, 60, 65, 70, 75, 80, 85, 90, or the like.

The rotor and mixer chamber (front/back door) temperature was set at 65-75° F. Other rotor and mixer chamber temperatures contemplated herein F include about 30 F up to about 95 F. More particularly, other rotor and mixer chamber temperatures contemplated herein can be selected from 30, 35, 40, 45, 50, 55, 60, 65, 70, 75, 80, 85, 90, 95 F, or the like.

The rotor speed was kept constant at 35 rpm during the mixing cycle. Other rotor speeds contemplated herein for batch weight include about 10 rpm up to about 100 rpm. More particularly, other rotor speeds contemplated herein can be selected from 10, 15, 20, 25, 30, 35, 40, 45, 50, 55, 60, 65, 70, 75, 80, 85, 90, 95, 100, or higher.

The compound was dropped at 155° F. During the mixing, the process parameters such as torque percentage, ram position, compound temperature, and the like, were recorded. Other dropping temperatures contemplated herein include about 100 F up to about 200 F. More particularly, other dropping temperatures contemplated herein can be selected from 100, 105, 110, 115, 120, 125, 130, 135, 140, 145, 150, 155, 160, 165, 170, 175, 180, 190, 195, 200, or higher.

Example of the formula structure:

TABLE 1

| | | EPDM/BIIR Composition |
|---|---|---|
| ITEM | MATERIAL | Weight % |
| 1 | HALOBUTYL RUBBER (BIIR) | 30-40 |
| 2 | EPDM RUBBER | 15-25 |
| 3 | FILLER | 15-25 |
| 4 | RESINS | 10-15 |
| 5 | PROCESS OIL | 0-3 |
| 6 | PROCESS AIDS | 0.5-5.0 |
| 7 | PIGMENTS | 1-5.0 |
| 8 | CURE PEROXIDE SYSTEM | 1-3 |
| | | 100% |

Range(Parts)

1st Stage: Mixing together by 2 min at 65-75° F.
in Banbury mixer (75 liters capacity)

| | |
|---|---|
| HALOGENATED RUBBER (BIIR) | 80-120 |
| EPDM | 40-60 |

2st Stage: adding rest of materials included cured
system (Zinc Oxide & Peroxide) (120-130° F.)

| | |
|---|---|
| OIL PROCESS | 0-6.0 |
| POLYBUTADIENE | 18.0-36.0 |
| Reinforced Filler | 45-65 |
| CARBON BLACK | 5.0-15 |
| GLASS BUBBLES | 0-30.0 |
| STEARIC ACID | 0.5-1.5 |
| CARBOWAX | 1-3 |
| Antistatic wax | 2.0-6.0 |
| Zinc Oxide | 0-10.0 |
| Peroxide | 5-10.0 |

1st sweep at minute 3 (135° F.-140° F.)
2nd sweep at minute 4 (145° F.-150° F.)
Download at 155° F.

When the drop temperature was reached, the compound was dropped and sheeted out with a two-roll mill.
a) Open cooling water valves in two-roll mil to avoid scorch of the Bromobutyl part.
b) Make rubber strip without pass though cooling water if it is by injection molding process.
c) Make rubber roll without pass though cooling water if it is by calendering & compression molding process.

Note: The EPDM/BIIR rubber mixture compound is affected if water is in contact him.

### Compression Process of Sleeve Rubber Grip Embodiment:

As is well-known in the art, the underlisting can be of conventional generally frustoconical configuration so as to taper in a converging manner from the butt end to the tip end thereof and is made of rubber. The rubber could be of any desired hardness but preferably has a durometer rating in the range of 55 to 60 so that the underlisting is hard enough to provide the torsional resistance desired for a golf grip. In another aspect, the underlisting rubber has a durometer rating in the range selected from 45 to 70; 50 to 65; 50 to 60; 55 to 70, so long as the underlisting is hard enough to provide the torsional resistance desired for a golf grip. The butt end 26 b of the underlisting has a beveled outer surface 33 to provide optimal joinder with the end cap during the molding process. The hollow interior of the underlisting is also of generally frustoconical configuration so as to generally conform with the taper of a golf club shaft and the underlisting is adapted to be slid over the butt end of the golf club shaft until the end cap abuts the butt end of the golf club shaft which properly positions the grip on the shaft. While the underlisting can be fabricated in any acceptable manner, conventional injection molding thereof has proven desirable.

The outer relatively soft invention rubber mixture composition layer 28 of the grip 22 is formed from at least one part and preferably two component parts in a manner to be described later which are integrated together during the compression molding process along the major length of the grip from the butt end to a location close to the tip end of the grip. The soft invention rubber mixture composition material in the outer layer 28 could be any desired softness but in one aspect has a durometer rating in the range of 35-40. In another aspect, the durometer rating is in the range selected from 25-75; 25-60; 25-50; 30-60; and 30-50. The skirt 32 at the tip end of the underlisting is made of any desirable rubber material but could be the same as the material from which the underlisting 26 is made and such that the skirt is flexible enough to facilitate an easy mounting of the grip on the butt end of a golf club shaft.

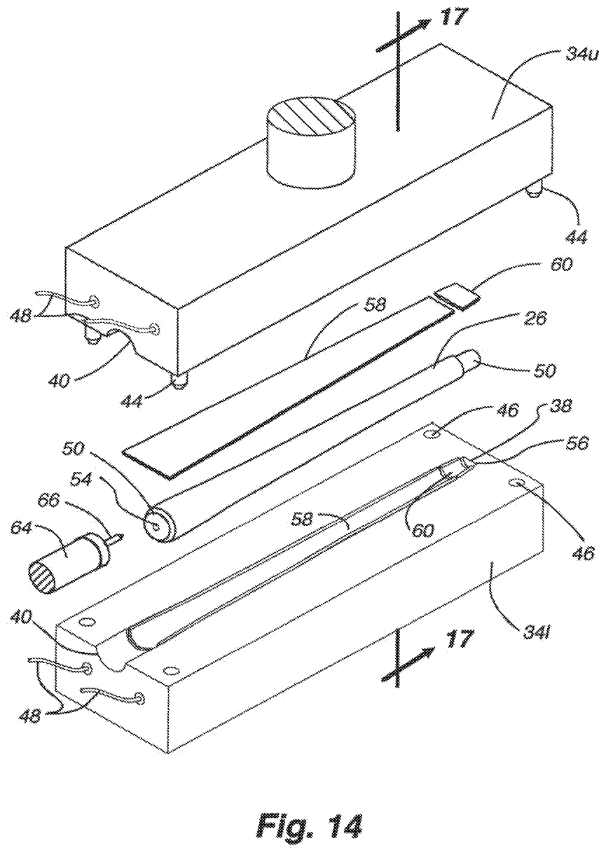

The grip is formed in a compression molding process which is best shown in FIGS. 14-20. The mold 34 in which the process is carried out includes a lower mold half 34L and an upper mold half 34U with each of the mold halves having a cavity 36 formed in a confronting face thereof to receive component parts of the grip for molding purposes. The cavities are closed at one end 38 of the associated mold half and open axially at the opposite end 40 of the mold half. The cavities may have a pattern 42 formed in a portion of the wall thereof so that the outer surface of the grip is formed with that same pattern and with the pattern typically being designed to facilitate improved gripping of the golf club. The upper mold half 34U has four guide pins 44 at its opposite corners while the lower mold half 34L has four mating guide recesses 46 so that the mold halves can be properly aligned for molding purposes. Electrical wires 48 are also provided for resistive heating of the mold halves so that the component rubber parts of the grip during the compression molding process are vulcanized into a unified grip of two distinct layers.

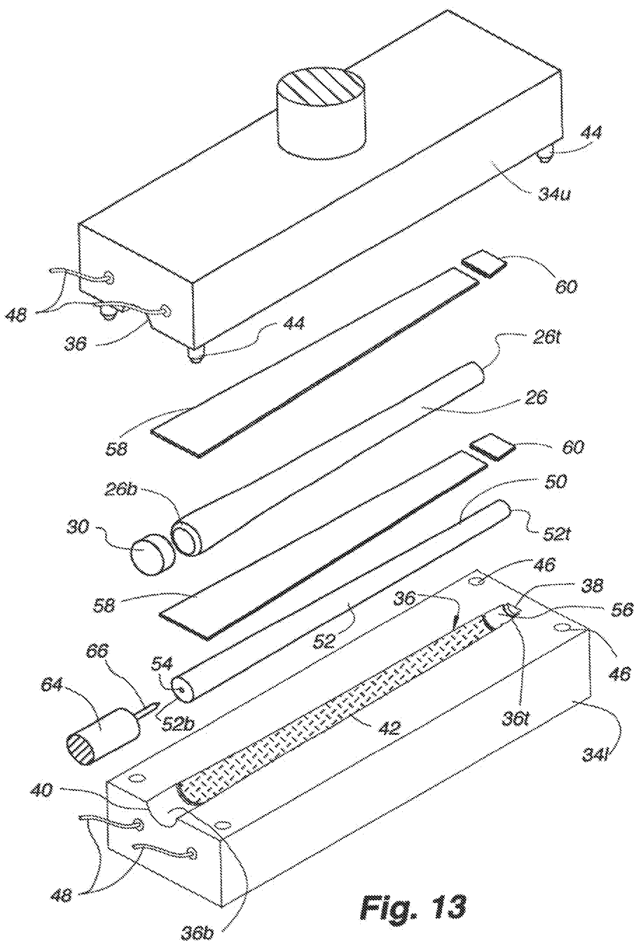

As best seen in FIGS. 13-20, to assemble the component parts of the grip for the molding process, an elongated incompressible mandrel 50 having a generally cylindrical main body 52 and a centering axial recess 54 at a butt end 52 b of the main body is inserted into the hollow interior of the previously molded underlisting 26.

The butt end 52 b of the main body of the mandrel is positioned in transverse alignment with the butt end 26 b of the underlisting. The tip end 52 t of the main body projects a short distance beyond the tip end 26 t of the underlisting so that it can rest in an arcuate cradle defined by an arcuate surface 56 in each mold half at the closed end of the mold. Before placing the underlisting 26 with the mandrel 50 therein into the lower mold half 34L, an elongated strip 58 of the invention soft rubber mixture composition material forming the outer layer 28, as best seen in FIGS. 7, 8 and 13, is laid into the cavity 36 in the lower mold half. The strip 58 is of generally trapezoidal configuration and has a width that is approximately half the circumference of the underlisting at each location along the length of the underlisting. A separate rubber tab 60 as best seen in FIGS. 11-13, also of trapezoidal configuration for forming a portion of the collar or skirt 32 at the tip end of the grip, is also positioned in the cavity in the lower mold at a tip end thereof and in longitudinal alignment with the elongated strip 58 adjacent to the arcuate surface 56. The elongated strip of the invention rubber mixture extends from a location spaced inwardly from the butt end 36 b of the cavity 36 to a location near the tip end 36 t of the cavity. The tab 60 is positioned in the mold half between the tip end of the elongated strip and the arcuate surface 56. The tab, which preferably has a durometer rating of about 55, has a width that is approximately equivalent to one half the circumference of the tip end 26 t of the underlisting. The underlisting with the mandrel therein is then placed in the cavity on the elongated strip 58 and the tab 60.

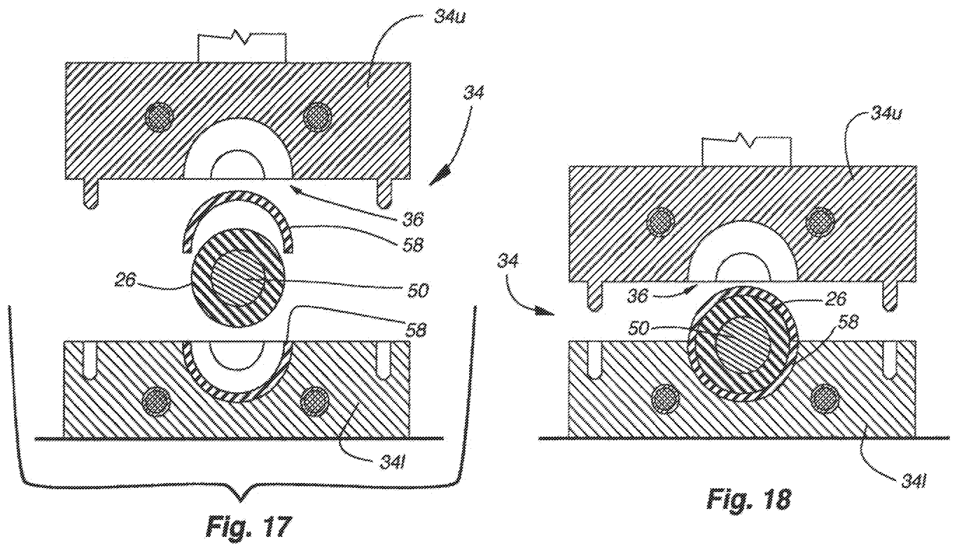

The open end of the mold 34 is in alignment with a cap bar 62 (FIGS. 13 and 16) that supports a cylindrical arm 64 having a cupped distal end with a pin 66 with a sharpened tip protruding axially therefrom and toward the cavities 36 formed in the mold halves. The cap bar 62 is mounted on a reciprocating plunger 68 and adapted to be moved toward and away from the mold such that the cylindrical arm 64 can be moved into the cylindrical opening 54 in the open end of the mold defined by the cavities in the mold halves until the sharpened pin 66 is received in the axial recess 54 of the mandrel 50. The cylindrical arm 64 of course is reciprocally mounted so as to be moveable into the open end of the mold and removable therefrom.

The end cap 30 is simply a solid disc of hard rubber (FIGS. 9, 10 and 13) having a durometer rating preferably in the range of 70-75. The end cap is positioned on the pin 66 (FIG. 14) adjacent to the butt end of the cavities. The pin is advanced through the axial center of the end cap so as to puncture an axial hole in the end cap which becomes a vent hole 72 in the finished grip. A second elongated trapezoidal strip 58 is then placed over the top of the underlisting 26 in vertical alignment with the first trapezoidal strip 58 and a second tab 60 of rubber material is placed on top of the exposed mandrel in vertical alignment with the first placed tab 60 of material.

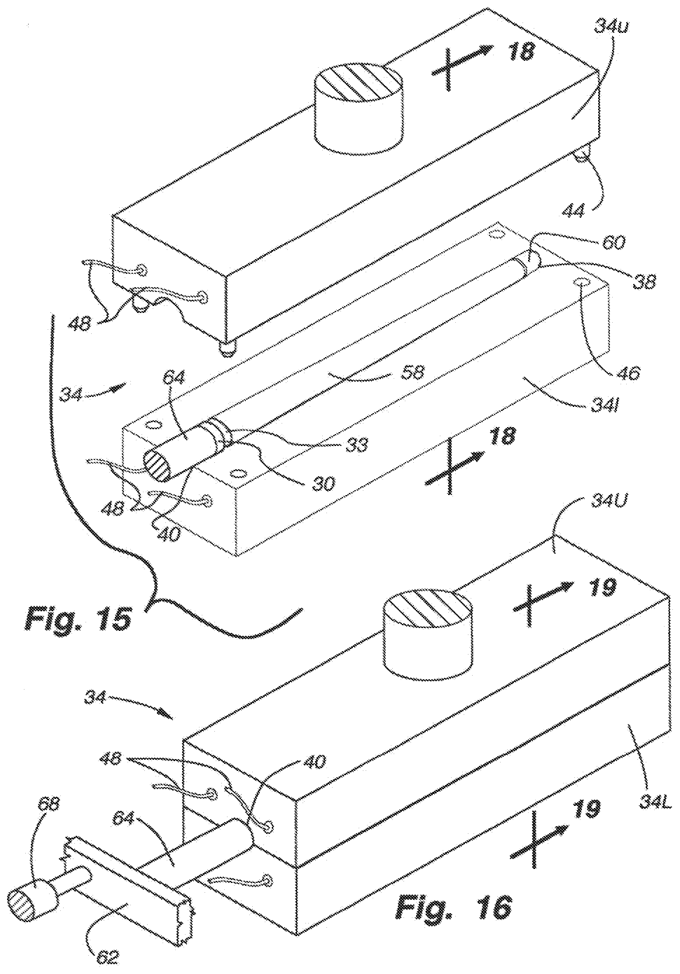

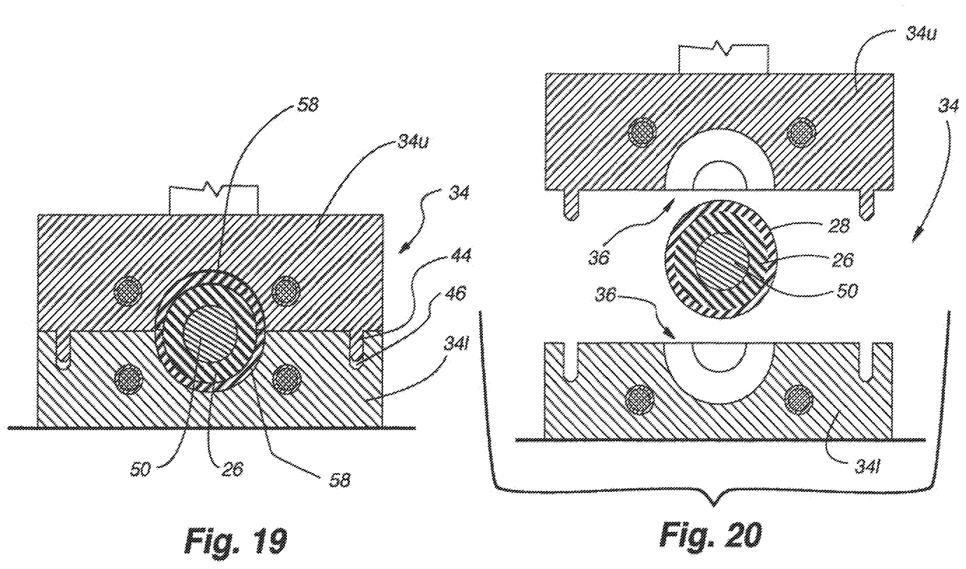

With the components of the grip thereby positioned on or within the lower mold half 34L (FIGS. 15 and 18), the upper mold half 34U is advanced downwardly into compressive relationship with the grip components with the guide pins 44 being received in the guide recesses 46 and with the grip components laid out in the lower mold half extending into the cavity in the upper mold half (FIGS. 16 and 19). The cylindrical arm 64 is advanced axially into the cylindrical opening 54 in the open end of the mold before or after it is closed (FIGS. 15 and 16) so that the sharpened pin 66 is received in the axial recess 54 of the mandrel and the end cap 30 is abutting the butt end of the underlisting. Thereafter, heat is applied to the mold. The heat is sufficient to vulcanize the various rubber components into an integrated unit under compression and after the vulcanization process, which lasts for a period of time that would be well known to those in the art, the upper half of the mold is lifted from the lower half (FIG. 20) and the cylindrical arm 64 is withdrawn leaving the end cap 30 vulcanized to the butt end 26 b of the underlisting. The grip with the mandrel 50 therein is thereafter removed from the lower half of the mold and finally the mandrel is withdrawn through the open tip end of the grip leaving the completed compression molded grip. Any excesses or flashing resulting from the molding process can be trimmed in a well-known manner.

The resulting grip 22 can be appreciated to include an injection molded underlisting 26 of rubber having predetermined and desired torsional resistance and an outer uniform covering 28 of a relatively soft invention rubber mixture composition material, advantageously providing desired tactile characteristics extending over the full length of the underlisting. At the butt end of the underlisting, the end cap 30, with the vent hole 72 therethrough, is vulcanized to the end of the underlisting so as to overlay the end of the golf club shaft when the grip is mounted thereon. At the tip end of the grip the rubber collar or skirt 32 is also vulcanized to the associated end of the underlisting so that the grip is relatively easy to position over the butt end of a golf club shaft when mounting the grip in a conventional manner on the shaft. Of course, the collar also becomes integrated with or vulcanized to the elongated invention rubber mixture composition rubber strips 58 forming the outer covering 28 of the grip during the compression molding process.

By forming the grip 22 with the compression molding process described in U.S. Pat. No. 7,264,759, the underlisting 26 can be made of one rubber material and the outer covering 28 can be made of a particular advantageous rubber mixture composition material in accordance with the present invention. The use of the particular improved invention rubber mixture compositions, as opposed to thermoplastics or the like, provides a distinct improved wet-tactile feel to the grip. As is well-known to those of skill in the art, the soft tacky-wet invention rubber mixture composition covering can be made of a different material or color than the collar to give the grip a distinct look and various gripping patterns can be molded into the soft invention rubber mixture composition cover as desired.

Although the present invention has been described with a certain degree of particularity, it is understood the present disclosure has been made by way of example, and changes in detail or structure may be made without departing from the spirit of the invention as defined in the appended claims.

What is claimed is:

1. A rubber mixture composition for improving physical and cosmetic characteristics of a golf club grip, the rubber mixture composition comprising a mixture of:
(a) from about 15% to about 25% by weight of a first rubber that can be crosslinked via peroxide; and
(b) from about 10% by weight to about 80% by weight of one or a combination of at least one second rubber that substantially-cannot be crosslinked by peroxide.

2. The rubber mixture composition of claim 1, wherein the first rubbers that can be crosslinked via peroxide are selected from the group consisting of: Natural rubber (NR), Polyisoprene (IR), Polybutadiene (BR), Polychloroprene (CR), Styrene butadiene rubber (SBR), Nitrile rubber (NBR), Hydrodenated nitrile rubber (HNBR), Silicone (Q), Polyurethane (AU/EU), Ethylene propylene copolymer (EPU), Ethylene propylene terpolymer (EPDM), Polyolefin elastomer (POE), Polysulfide (T), Polyethylene (PE), Chlorinated polyethylene (CM), Chlorosulfonated polyethylene (CSM), Ethylene vinylacetate copolymer (EVA), Acrylonitrile butadien styrene copolymer (ABS), Ethylene acrylic (AEM), Ethylene butylacrylate copolymer (EBA), Fluoro elastomers (FKM). In addition, other first rubbers that can be crosslined via pereoxide include blends selected from the group consisting of: Nitrile rubber/EPDM, SBR/EPDM, PE/EPDM (TPV's), PE/EVA, NBR/EVA, POE/EPM and POE/EPDM.

3. The rubber mixture composition of claim 1, wherein the second rubbers that cannot be crosslinked via pereoxide are selected from the group consisting of: halogenated butyl rubber, Bromobuty rubber and Chlorobutyl rubber, Polyacrylate (ACM), Epichlorohydrin (CO), Epichlorohydrin copolymer (ECO), Polypropylene (PP), Polybutene-1 (PB), Polyisobutene (PIB), and Polyvinylchloride (PVC).halogenated rubber is a butyl, brominated or chlorinated butyl rubber.

4. The rubber mixture composition of claim 3, wherein the halogenated butyl rubber is brominated butyl rubber; or wherein the halogenated butyl rubber is chlorinated butyl rubber; or wherein the halogenated butyl rubber is a combination of brominated butyl rubber and chlorinated butyl rubber.

5. The rubber mixture composition of claim 1, further comprising from about 10% by weight to about 50% by weight of a filler selected from the group comprising silica, titanium dioxide, calcium carbonate, barium sulfate, silicon dioxide, carbon black, sand, glass beads, ceramic spheres, mineral aggregates, talc, clay and thermoplastic microspheres.

6. The rubber mixture composition of claim 1, further comprising from about 0% by weight to about 8% by weight of a plasticizer selected from the group consisting of naphthenic oils, paraffinic oil, aromatic plasticizers, and hydrotreated naphthenic distillate.

7. The rubber mixture composition of claim 1, wherein the second rubber comprises from about 30% by weight to about 240% by weight of halogenated butyl rubber and the first rubber comprises from about 15% by weight to about 25% by weight of EPDM.

8. The rubber mixture composition of claim 1, further comprising from about 0% by weight to about 30% by weight of amorphous silicon dioxide.

9. The rubber mixture composition of claim 1, further comprising from about 0% by weight to about 20% by weight of a plasticizer, from about 0% by weight to about 20% by weight of a tackifier, and from about 1% to about 15% of a pigment.

10. The rubber mixture composition according to claim 1, wherein the first rubber comprises a peroxide curing system.

11. A method of making a grip for a sporting implement comprising the steps of: providing a tubular elastomeric base member of substantially the full length of the grip, providing a compression mold, providing at least one strip of the rubber mixture composition of claim 1, of substantially the full length of the grip but of a different hardness than said base member, placing said rubber mixture composition strip in overlying engaging relationship with said base member in said mold, and then compression molding the placed rubber mixture composition strip to said base member under heat to vulcanize the rubber mixture composition strip to the base member.

12. The method of claim 11, wherein said strip of a rubber mixture composition is at least two strips of rubber mixture composition placed on opposite sides of said base member in said mold; or wherein said strips of rubber mixture composition have a width and the aggregate width of said strips of material is substantially the same as the circumference of said tubular base member so as to completely surround said tubular base member when molded thereto.

13. The method of claim 12, further including the step of placing an end cap in said mold adjacent to and in longitudinal alignment with one end of said tubular base member, said end cap also being compression molded to said base member under heat so as to be vulcanized to said base member.

14. The method of claim 12, further including the step of placing a mandrel in said tubular member prior to compression molding said strips to said base member.

15. The method of claim 14, wherein said tubular base member is injection molded prior to placement of the base member into said compression mold.

16. The method of claim 11, wherein, the outer surface of said base member is frustoconical in configuration and said strips of rubber mixture composition are trapezoidal in configuration.

17. The method of claim 16, wherein there are only two of said strips of rubber mixture composition.

18. The method of claim 11, wherein said base member and strip of rubber mixture composition are rubber.

19. The method of claim 16, wherein said base member and strips of rubber mixture composition are different rubbers.

20. The method of claim 19, wherein said base member has a higher durometer rating than said strips of rubber mixture composition.

21. The method of claim 11, wherein the durometer rating of said base member is in the range of 55-60 and the durometer rating of said strips of a rubber mixture composition is in the range of 35-40.

22. The method of claim 13, further including the step of placing tab material in contiguous alignment with said tubular base member at the opposite end from said end cap such that said tab material is vulcanized to said base member during the compression molding step.

23. The method of claim 22, wherein said tab material is rubber and of a different durometer rating than said strip of an elastomeric rubber mixture composition material.

24. The method of claim 23, wherein there are a plurality of pieces of said tab material each having a width with the aggregate widths of said tab material being substantially the same as the circumference of said base member in the location where said tab material is placed on said base member.

25. A golf grip for a golf club comprising:
a body forming a shaft cavity for receiving a shaft of the golf club, the body having
a closed end,
an open end,
a composite shell comprising the rubber mixture composition of claim 1, forming a continuous surface from the open end to the closed end,
a foam layer inward of, adjoining, and integral to the composite shell;
a cap integral to the body at the closed end of the body, where the shaft cavity extends from the open end to the cap;
a core tube inward of, adjoining, and integral to the foam layer; and
core protrusions extending from the core tube to the composite shell through the foam layer.

26. The golf grip of claim 25, wherein the core protrusions include a rib that subdivides the foam layer into foam layer sections; or wherein the core tube includes an elastomeric material; or wherein the foam layer includes closed cell polyurethane foam.

27. The golf grip of claim 26, further comprising a surface coating located at an outer surface of the composite shell.

28. A golf grip for a golf club comprising:
a core tube forming a shaft cavity;
a composite shell surrounding the core tube, the composite shell comprising the rubber mixture composition of claim 1, wherein the composite shell forms a hard outer shell having a continuous surface from a first end to a second end, the first end of the composite shell contacting the core tube adjacent an open end of the grip;
a cap adjoining the core tube and the second end of the composite shell to form a closed end of the grip opposite the open end; and
a foam layer filling a volume enclosed by the cap, the composite shell, and the core tube, where the composite shell, the foam layer, the core tube, and the cap are integral.

29. The golf grip of claim 28, further comprising core protrusions extending from the core tube to the composite shell through the foam layer.

30. The golf grip of claim 29, wherein the core protrusions include a rib that subdivides the volume between the cap, the composite shell, and the core tube, and wherein the foam layer is subdivided into foam layer sections; or wherein the foam layer includes closed cell polyurethane foam, and the core tube and the core protrusions include an elastomeric material.

31. The golf grip of claim 28, wherein the core tube extends beyond the composite shell at the open end forming a tip of elastomeric material.

32. The golf grip of claim 28, further comprising a texture layer that forms tactile features on the grip.
